(19) United States
(12) Patent Application Publication
(10) Pub. No.: US 2025/0390350 A1
(43) Pub. Date: Dec. 25, 2025

(54) SYSTEMS AND METHODS FOR USE IN INHIBITING EVENT LOSS IN EVENT-DRIVEN SCHEMES

(71) Applicant: MASTERCARD INTERNATIONAL INCORPORATED, PURCHASE, NY (US)

(72) Inventors: Manuj Arora, Pune (IN); Jaydeep R. Rajput, Pune (IN); Rushabhkumar Bharatbhai Vashi, Pune (IN)

(21) Appl. No.: 19/210,978

(22) Filed: May 16, 2025

Related U.S. Application Data
(60) Provisional application No. 63/663,468, filed on Jun. 24, 2024.

(51) Int. Cl. G06F 9/50

(52) U.S. Cl. CPC G06F 9/5027

(57) ABSTRACT

Systems and methods are provided for inhibiting missed events in an event driven scheme. One example computer-implemented method includes publishing events to a message bus to a first topic during an audit interval, where each of the events is associated with a unique event identifier (ID). The method also includes, for each of the events published, incrementing a count for the audit interval and then, after the audit interval: publishing an audit event, which includes the audit count for the audit interval; in response to a request for event IDs, from a consumer of the message bus, providing the event IDs for each of the events; and in response to a request to republish missing ones of the events, from the consumer of the message bus, republishing the missing ones of the events, to the message bus, to a second topic.

### CROSS-REFERENCE TO RELATED APPLICATION

This application claims the benefit of, and priority to, U.S. Patent Application No. 63/663,468, filed on Jun. 24, 2024. The entire disclosure of the above application is incorporated herein by reference.

### FIELD

The present disclosure is generally directed to systems and methods for use in inhibiting event loss in event-driven schemes/architectures, and in particular, to facilitating identification of instructions for republication to avoid missed events in stateless processing.

### BACKGROUND

This section provides background information related to the present disclosure, which is not necessarily prior art.

Data is known to be stored in databases and communicated between different users and systems. A number of different channels are known to be used to communicate the data. Among the channels, more recently, event-driven architectures rely on events published on message buses, by producers or publishers, to be consumed by consumers or subscribers, based on topics to which the events are published.

The event-driven architectures may be employed in situations in which sequential or parallel processing of data may be required, which may be performed by consumers of data from the message buses, whereby the consumers publish results of the processing back to the message buses.

### DRAWINGS

The drawings described herein are for illustrative purposes only of selected embodiments and not all possible implementations, and are not intended to limit the scope of the present disclosure.

FIG. 1 is an example system of the present disclosure suitable for inhibiting event loss for events published to a message bus, consistent with an event-driven scheme;

FIG. 2 is a block diagram of an example computing device that may be used in the system of FIG. 1; and

FIG. 3 includes a flow diagram for an example method, which may be implemented in connection with the system of FIG. 1 for inhibiting event loss among events published to a message bus, where a subscriber verifies a count of events for an audit interval and reconciles the count to identify lost events to be republished.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Event-driven architectures rely on subscribers consuming events published to message bus or stream processing platform. The event-driven architectures are, by definition, different than directed communication from a specific source to a specific recipient, which are often synchronized (e.g., point-to-point channels, etc.). From time to time in event-driven architectures, the subscribers are not able to consume the events due to, for example, network/infrastructure issues, consumers being unhealthy etc. Depending on the basis for communication, the missed events may be problematic and/or may cause subsequent failures in the communications. In account transaction processing, for example, it is crucial, in most instances, for subscribers to consume all transaction-related events to avoid related failures, missed transactions, duplicate transactions, etc. On the scale of millions, or billions of transactions (i.e., in a commercial processing network), missed events are difficult to identify, yet may be critical to proper operation and remediation in the overall transaction processing.

Uniquely, the systems and methods herein provide for audit intervals, and event counts specific thereto, whereby subscribers are informed of events and permitted to reconcile consumed events in each audit interval and, as necessary, request missed events for the specific audit interval.

In particular, producers in the event driven architecture, which generate events related to transactions, maintain audit counts of the events published to a message bus, in general or per topic, during given audit intervals. Subsequent to the given intervals (e.g., as each is completed, etc.), the producers publish the audit counts as events to the message bus, along with the event category-wise breakup, which are consumed by subscribers. The subscribers, which also count the consumed events from the message bus for the published audit counts, verify the subscribers' counts relative to the audit counts received from the publishers. If the audit counts match, no events published to the message bus have been missed. If the counts do not match, the subscribers request listings of event IDs for the audit intervals (for the events published to the message bus during the audit intervals), which the producers provide. The subscribers then compare the event IDs for the audit intervals to identify the missing event(s) by the event IDs. The subscribers then request republication of the missing events by the event IDs (which are republished by the producers to the message bus) and consume the same.

In this manner, the producers provide audit counts, per audit interval, to permit the subscribers to verify the events consumed from the message bus, and also respond with requests for republication when events were missed. As such, the subscribers avoid missing any events from audit interval to audit interval, which provides for avoidance of failure of the stateless system/methods for missed and unremedied events.

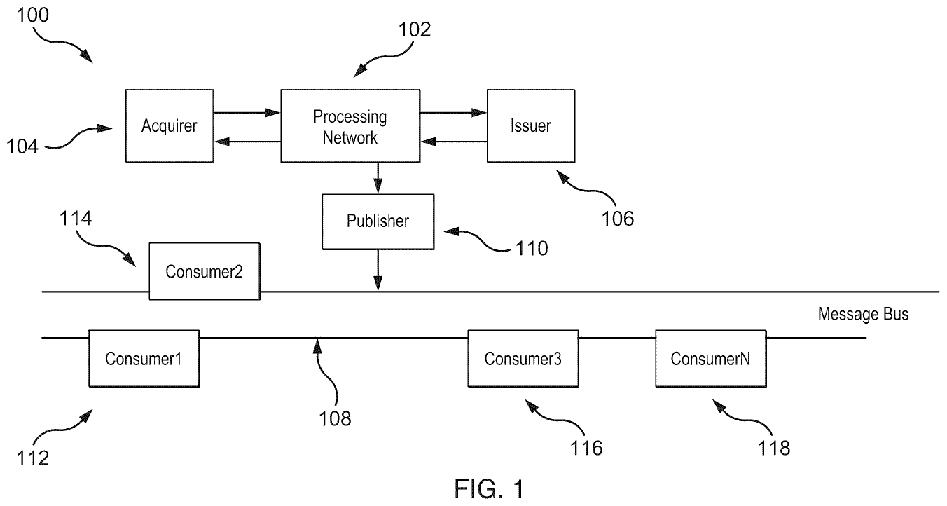

FIG. 1 illustrates an example system 100, in which one or more aspects of the present disclosure may be implemented. Although the system 100 is presented in one arrangement, other embodiments may include the parts of the system 100 (or other parts) arranged otherwise depending on, for example, communication schemes, distribution of data, types and numbers of producers/subscribers, security requirements associated with databases, etc.

The illustrated system 100 includes a processing network 102, which is coupled to an acquirer 104 and an issuer 106.

In this example embodiment, the acquirer 104 is a bank or other financial institution, which is configured to participate in payment transactions, in which funds are transferred from accounts issued by another bank (or banks) into an account issued by the acquirer 104. The payment transactions are directed to users to which the accounts are issued (e.g., merchants, persons, etc.). Similarly, the issuer 106 is a bank or other financial institution, which is configured to participate in payment transactions, in which funds are transferred from an account(s) issued by the issuer 106 into an account(s) issued by another bank (e.g., the acquirer 104, etc.). The payment transactions are directed from (or funded by) users to which the accounts are issued (e.g., businesses, persons, etc.).

The processing network 102 is configured to facilitate messaging representative of the payment transactions, such as, for example, authorization, clearing, settlement, etc., messaging., which form, in general, a processing switch for payment account transactions.

In connection with processing the payment transactions, the processing network 102 is configured to provide one or more services for the transactions. The services may include, without limitation, loyalty services, fraud monitoring services, audit logging services, message routing services, cryptographic services, tokenized processing, etc.

In this example embodiment, the processing network 102 is configured consistent with an event-driven architecture, which includes a message bus 108, an event publisher 110 and multiple event consumers 112-118 (as shown in FIG. 1).

In connection therewith, the event publisher 110 is configured to compile an event and to publish the event to the message bus 108. The message bus 108, in turn, is configured to receive the event from the event publisher 110 and to persist messages to be consumed by the consumers 112-118. The consumers 112-118 are configured to consume the events/messages from the message bus 108 and to perform, as appropriate, one or more of the above services, etc. In this way, the consumer 112, for example, may be configured to perform monitoring service(s), while the consumer 114 is configured to provide reporting service(s), etc. As part of the above, the consumer 116, for example, may be configured to compile and publish an event back to the message bus 108, where the event includes the result of the service(s) performed for the consumed event.

The message bus 108, the event publisher 110 and the consumers 112-118 are configured to operate in the above manner for hundreds of thousands, million, etc., events over time intervals of hours, etc.

Given the above, in this example embodiment, the processing network 102 is configured to receive a transaction massage from the acquirer 104 (e.g., an authorization message, etc.), via an edge device (not shown) such as, for example, an interface processor (e.g., MASTERCARD interface processor (MIP), etc.), etc. The message is provided to the publisher 110. The publisher 110 is configured to compile an event specific to the message and to publish the event on the message bus 108. The event is published to a specific message topic and includes data indicative of the message, and also a message ID and certain metadata specific thereto. In this example embodiment, the event may include, for the example transaction described above, encrypted transaction data (e.g., account number, transaction amount, currency, acquirer ID, consumer data, time/date of transaction, transaction ID, terminal ID, merchant data, etc.) along with metadata including event ID, publish timestamp and one or more other identifiers associated with the event or underlying transactions, etc.

It should be appreciated that the message bus 108 is configured as a stateless switch, which does not hold a state of the transaction in any persistence technology or databases, etc., with communication occurring over events/messages over message bus 108. This is in contrast to a stateful switch, in which intermediate steps in transaction processing are persisted on databases as states.

In addition, uniquely, in this example embodiment, the publisher 110 is configured to define a count for the events and to increment the count based on the event being published to the message bus 108. The count may be specific to a topic, whereby only events to that specific topic are counted. The publisher 110 increments the count similarly for each event to the topic. Additionally, the count is defined for an audit interval, whereby the count may also be referred to as an audit count. A duration of the audit interval is specific to the implementation, and may include, without limitation, thirty minutes, an hour, or more or less, etc., which may be potentially dependent on the publisher 110, etc. In connection therewith, the publisher 110 is configured to store the audit count at the end of the audit interval (i.e., when the audit interval is completed, or expired) in association with the audit interval (e.g., 117,500 events published to topic.1 in audit interval 10:00-10:15 on May 21, etc.), and then to reset the audit count for the next audit interval.

Referring again to the example event, which is representative of a transaction, the consumer 112 is configured to perform at least one service for transactions messages for events published to a specific topic (e.g., topic.1, etc.), whereby the consumer 112 is a subscriber to that topic. As such, the consumer 112 is configured to consume the example event, which includes topic.1 as the topic. The consumer 112 is configured to then perform one or more services for the transaction message represented by the event, and in this example, to compile a further event which is indicative of a result of the one or more services and to publish the event to the message bus 108.

In addition, the consumer 112 is configured to define a count of events to topic.1 and to increment the count for each event specific to the topic consumed thereby. As above, the count is specific to the audit interval, and maintained and reset in a manner consistent with the above.

It should be understood that for the transaction message, multiple events may be compiled and published to the message bus 108 to account for authorization, clearing and settlement thereof, as appropriate, each event being consistent with the above.

From time to time, the event publisher 110 is configured to publish the audit count, and identify the audit interval as an event to the message bus 108, under a topic such as, for example, topic.1.audit_count. The consumer 112, in this example, is a subscriber to this additional topic. As such, the consumer 112 is configured to consume the audit event from the message bus 108 based on the topic being topic.1.audit_count. In turn, the consumer 112 is configured to compare the audit count from the event publisher 110 to the audit count that the consumer 112 maintained, i.e., for the same audit interval.

In response to the counts being a match, the consumer 112 is configured to confirm all events for the topic from the event publisher 110, whereby the audit interval is marked complete.

Conversely, in response to the counts being a mismatch, the consumer 112 is configured to request the event IDs for events published by the event publisher 110 within the audit interval, for example, as an event published to the message bus 108. The event is published to a separate topic, to which the event publisher 110 is subscribed, such as, for example, topic1.audit.list_identfiers. The event publisher 110 is configured to retrieve the unique event IDs for the events published during the audit interval and to respond, via the message bus 108, to the request with the unique event IDs for the events published during the audit interval. The response from the event publisher 110 may also be associated with a specific topic, to which the consumer 112 is subscribed, with an indication or identifier specific to the request published by the consumer 112.

The consumer 112 is configured to reconcile the unique event IDs from the event publisher 110 with the event IDs for the events received, by the consumer 112, during the audit interval. The consumer 112 is configured to then request republication of discrepancies, i.e., the missed event-based event IDs. The event publisher 110 is configured to again compile the events associated with the event IDs, and then, to republish the events identified by the event IDs to a republication topic, which may be specific to the consumer 112 (e.g., topic.1.republish_consumer 112, etc.), on the message bus 108.

The consumer 112 is configured to then consume the republished events, as published to the message bus 108. Consistent with the above, the consumer 112 is configured to perform the one or more services for the events, and to respond, as appropriate. When each of the event IDs for the missed events is consumed, the consumer 112 is configured to designate the audit interval as complete.

It should be appreciated that each of the consumers 114-118 is similarly configured for specific topics.

The event publisher 110, the message bus 108, and the consumers 112-118 are configured to continue to operate in this manner for consecutive audit intervals, etc.

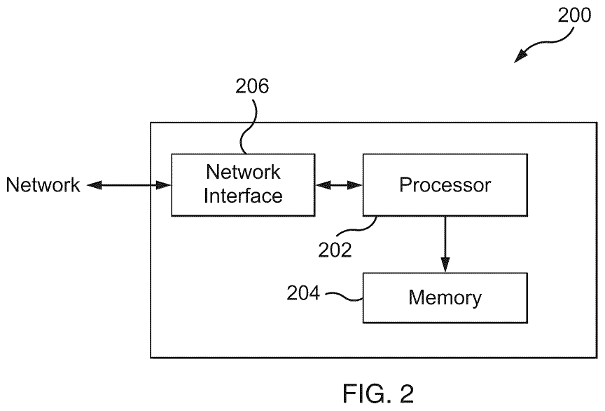

FIG. 2 illustrates an example computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, the processing network 102, the acquirer 104, the issuer 106, the message bus 108, the event publisher 110, and the consumers 112-18 are and/or include one or more computing devices, either together or separately, which include and/or are generally consistent with the computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, primary data, messages, entries, annotations, topics, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special purpose computing device. It should be appreciated that the memory 204 may include a variety of different memories, each implemented in one or more of the operations or processes described herein.

The illustrated computing device 200 also includes a network interface 206 coupled to (and in communication with) the processor 202 and the memory 204. The network interface 206 may include, without limitation, a wired network adapter, a wireless network adapter, a mobile network adapter, or other device capable of communicating to one or more different ones of the networks, and/or with other devices described herein. In some example embodiments, the computing device 200 may include the processor 202 and one or more network interfaces incorporated into or with the processor 202.

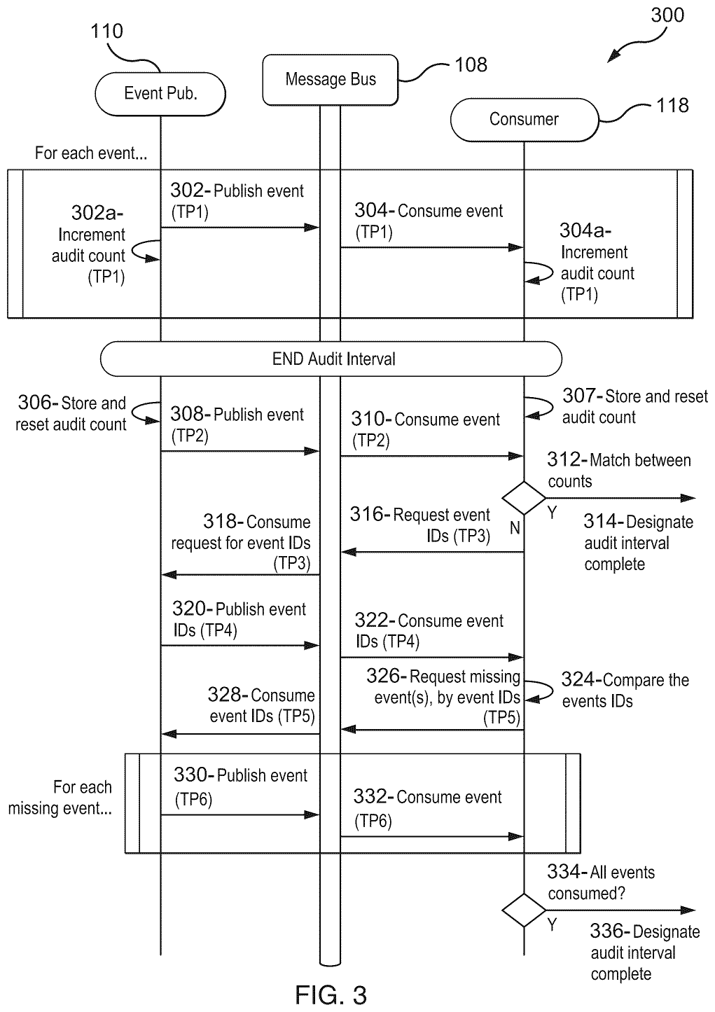

FIG. 3 illustrates an example method 300 for use in inhibiting event loss along a message bus, where a subscriber verifies a count of events and reconciles the count to identify lost events to be republished. The example method 300 is described as implemented in the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, in general, the event publisher 110 publishes (e.g., as a publisher computing device generally consistent with computing device 200, etc.) events to the message bus 108, and the consumer 118, in this example, consumes (e.g., as a consumer computing device generally consistent with computing device 200, etc.) the events from the message bus 108.

In particular, as shown, at 302, the event publisher 110 publishes an event to the topic TP1 on the message bus 108, whereby the message bus 108 permits the event to be consumed based on the topic. In connection therewith, at 304, the consumer 118, which is subscribed to the topic TP1, consumes the event from the message bus 108. The event may include any suitable information to be communicated from the publisher 110 to the consumer 118 (and other consumers). In one example, the event is related to a transaction, whereby the content of the event includes details of the transaction to be implemented, completed, etc., by the consumer 118, or multiple consumers, where the event is the basis for multiple events to the message bus 108.

Importantly, it should be noted that, from time to time, however, when the event is published to the message bus 108 to the topic TP1, the event is missed or not consumed by the consumer 118 despite the consumer 118 subscribing to topic TP1.

Regardless, in connection with the publication of the event, the event publisher 110 also increments an audit count for the topic TP1, at 302a, based on the event being published to the message bus 108, and the consumer 118 increments an audit count for the topic TP1, at 304a, for all events to that topic that are consumed. In this way, each of the event publisher 110 and the consumer 118 maintain a count of the events published to the message bus 108 or consumed from the message bus 108. As illustrated in FIG. 3, the steps 302 and 304 (potentially) are repeated for each event originating at the event publisher 110.

Consistent with the above, the audit counts are each associated with a specific audit interval. The audit interval may be any suitable amount of time. In general, audit intervals run consecutively (e.g., audit interval 1, audit interval 2, audit interval 3, etc.), whereby when an event is published to the message bus 108, one and only one audit count for the event publisher 110 is incremented, yet no event is published without an audit count being incremented. That is, each event is associated with one audit interval. In this way, the audit counts reflect all events, to a specific topic, published and consumed between the event publisher 110 and the consumer 118.

It should be appreciated that for each audit interval, although not shown, the event publisher 110 and the consumer 118 each store the event IDs of the events published, or consumed, respectively. The event IDs are associated with the specific audit interval, in which the event is published/consumed.

For a particular audit interval, after the end of the audit interval (e.g., the event publisher 110 determines that the audit interval is complete, etc.), the event publisher 110 stores the audit count and resets the audit count for the next audit interval, at 306. The audit count may be stored in association with the topic and also a description of the audit interval, which permits the audit interval to be compared and/or matched with audit intervals from consumers. Similarly, at 307, after the end of the audit interval (e.g., the consumer 118 determines that the audit interval is complete, etc.), the consumer 118 stores the audit count for the audit interval and also resets the audit count for the next audit interval.

At 308, the event publisher 110 compiles and publishes an audit event to the topic TP2 to the message bus 108. In this example embodiment, the topic TP2 is specific to audit events, and the consumer 118 is subscribed to topic TP2, which is different than the topic TP1. As such, the consumer 118 consumes, at 310, from the TP2 topic, the audit event, which includes the audit count from the event publisher 110 for the completed audit interval. In response, the consumer 118 retrieves its own audit count for the specific, completed audit interval (e.g., based on time and date, etc.), and compares the audit count from the event to the retrieved audit count, at 312, to determine whether there is a match, or not. When there is a match between the two audit counts for the specific audit interval, the consumer 118 designates the specific audit interval as complete (or successfully audited or without missing events), at 314. The consumer 118 then proceeds back to consuming events consistent with step 304 in a next or subsequent audit interval. The event publisher 110 continues in publishing events, consistent with step 302, in the next or subsequent audit interval.

Conversely when there is no match between the audit counts for the specific audit interval, the consumer 118 compiles and publishes, at 316, an event to the message bus 108 as a request for event IDs for the specific audit interval. This event is published to an audit topic TP3, which is reserved for events specific to audits (or audit events) and which is different than the first topic TP1 and the second topic TP2. The event identifies the audit interval by identifier, time, date, etc. In turn, the event publisher 110 consumes, at 318, the request for event IDs based on the topic TP3. The event publisher 110 then retrieves all of the event IDs for the specific audit interval (e.g., based on the identifier, time, date, etc., of the audit interval indicated in the event, etc.) and returns, at 320, the event IDs in an audit event published to yet another audit topic specific to publishing of event IDs, which, in this example, is topic TP4, to the message bus 108. The topic TP4 is again unique and different than the other topics above. At 322, consumer 118 consumes the event including the event IDs, from the topic TP4, for the audit interval.

At 324, the consumer 118 compares the event IDs from the event publisher 110 to the event IDs recorded/stored by the consumer 118 for the specific audit interval. In doing so, the consumer 118 identifies one or more missing event(s) based on which event IDs received from the event publisher 110 (i.e., published events) are absent from the recorded event IDs by the consumer 118 (i.e., consumed events). Upon or in response to identifying one or more missing events, at 326, the consumer 118 requests the missing events, as an event published to the message bus 108, to the topic TP5, which is unique and different than the topics above and specific, again, to audit events. The event includes the event IDs identified by the consumer 118 for the one or more missing events during the specific audit interval.

In turn, at 328, the event publisher 110 consumes the event, including the event IDs, from the message bus 108, from the topic TP5. The event publisher 110 then retrieves the missing events from memory based on the event IDs. And, as shown in FIG. 3, for each of the missing events, the event publisher 110 publishes, at 330, the event to a new topic, which is topic TP6 in this embodiment. The topic TP6 is unique and different than the topics above. In turn, the consumer 118 is subscribed to the topic TP6 and consumes, at 332, the missing event from the message bus 108 published to the topic TP6. Steps 330 and 332 are repeated as required to republish each of the missing events. In connection therewith, at 334, the consumer 118 determines that all of the one or more missing events have been consumed from the topic TP6 and designates, at 336, the audit interval to be complete (or successfully audited or without missing events). The consumer 118 then proceeds back to consuming events consistent with step 304 in a next or subsequent audit interval. The event publisher 110 continues in publishing events, consistent with step 302, in the next or subsequent audit interval.

It should be appreciated that the audit steps from 306-336 may be repeated, in whole or in part, for each audit interval between the event publisher 110 and each of the consumers 112-118, to ensure that no events published to a specific topic are missed by the consumers.

In view of the above, the systems and methods herein provide for audit within the event-driven architecture implementations described herein, through audit counts for audit intervals.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved b: (a) publishing, by a publisher computing device, a plurality of events to a message bus to a first topic during an audit interval, each of the plurality of events associated with a unique event identifier (ID); (b) for each of the plurality of events published, incrementing, by the publisher computing device, a count for the audit interval; and/or (c) after the audit interval: (i) publishing, by the publisher computing device, an audit event, which includes the audit count for the audit interval; (ii) in response to a request for event IDs, from a consumer of the message bus, providing the event IDs for each of the plurality of events; and/or (iii) in response to a request to republish missing ones of the plurality of events, from the consumer of the message bus, which includes ones of the event IDs, republishing, by the publisher computing device, the missing ones of the plurality of events, to the message bus, to a second topic, which is different than the first topic.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in inhibiting missed events in an event-driven scheme, the method comprising:
publishing, by a publisher computing device, a plurality of events to a message bus to a first topic during an audit interval, each of the plurality of events associated with a unique event identifier (ID);
for each of the plurality of events published, incrementing, by the publisher computing device, a count for the audit interval; and then
after the audit interval:
publishing, by the publisher computing device, an audit event, which includes the audit count for the audit interval;
in response to a request for event IDs, from a consumer of the message bus, providing the event IDs for each of the plurality of events; and
in response to a request to republish missing ones of the plurality of events, from the consumer of the message bus, which includes ones of the event IDs, republishing, by the publisher computing device, the missing ones of the plurality of events, to the message bus, to a second topic, which is different than the first topic.

2. The computer-implemented method of claim 1, wherein providing the audit count includes publishing the audit count to the message bus.

3. The computer-implemented method of claim 2, wherein publishing the audit count to the message bus includes publishing the audit event to a third topic, which is different than the first topic and the second topic.

4. The computer-implemented method of claim 1, further comprising:
determining, by the publisher computing device, that the audit interval is complete; and
retrieving, by the publisher computing device, the event IDs for the audit interval, prior to providing the event IDs for each of the plurality of events.

5. The computer-implemented method of claim 1, further comprising:
retrieving, by the publisher computing device, form a data structure, the missing ones of the plurality of events, prior to republishing the missing ones of the plurality of events.

6. The computer-implemented method of claim 1, wherein the publisher computing device and the message bus are integrated into a processing network transaction switch.

7. The computer-implemented method of claim 6, wherein each of the plurality of events is based on a transaction message.

8. A computer-implemented method for use in inhibiting missed events in an event-driven scheme, the method comprising:
consuming, by a consumer computing device, a plurality of events specific to a first topic from a message bus during an audit interval, each of the plurality of events associated with a unique event identifier (ID);
for each of the plurality of events consumed, incrementing, by the consumer computing device, a first audit count for the audit interval; and then
after the audit interval:
consuming, by the consumer computing device, an audit event, which includes a second audit count from a publisher for said audit interval for the first topic;
comparing, by the consumer computing device, the first audit count and the second audit count;
in response to a mismatch between the first audit count and the second audit count, requesting event IDs, from the publisher, for published events to the first topic for the audit interval;
in response to the events IDs, from the publisher, reconciling the event IDs from the publisher with the event IDs of the plurality of events consumed by the consumer computing device during the audit interval; and
requesting, by the consumer computing device, from the publisher, replication of missing ones of the events based on the reconciliation.

9. The computer-implemented method of claim 8, further comprising determining, by the publisher computing device that the audit interval is complete; and
wherein consuming the audit count includes consuming the audit count as an event to the message bus specific to a second topic, which is different than the first topic.

10. The computer-implemented method of claim 9, further comprising consuming republished ones of the missing ones of the events, based on subscription to a third topic to which the republished ones of the missing ones of the events are published, the third topic different than the first topic and the second topic.

11. The computer-implemented method of claim 8, further comprising, after requesting replication of the missing ones of the event, consuming republished ones of the missing ones of the events, based on subscription to a third topic.

12. The computer-implemented method of claim 8, wherein the consumer computing device and the message bus are integrated into a processing network transaction switch.

13. The computer-implemented method of claim 12, wherein each of the plurality of events is based on a transaction message.

14. A non-transitory computer-readable storage medium comprising executable instructions, which when executed by at least one processor of a publisher computing device, cause the at least one processor to:
publish a plurality of events to a message bus to a first topic during an audit interval, each of the plurality of events associated with a unique event identifier (ID);
for each of the plurality of events published, increment a count for the audit interval; and then
in response to the audit interval being complete:
publish an audit event, which includes the audit count for the audit interval;
in response to a request for event IDs, from a consumer of the message bus, provide the event IDs for each of the plurality of events; and
in response to a request to republish missing ones of the plurality of events, from the consumer of the message bus, which includes ones of the event IDs, republish the missing ones of the plurality of events, to the message bus, to a second topic, which is different than the first topic.

15. The non-transitory computer-readable storage medium of claim 14, wherein the executable instructions, when executed by the at least one processor of the publisher computing device, cause the at least one processor, in providing the audit count, to publish the audit count to the message bus.

16. The non-transitory computer-readable storage medium of claim 15, wherein the executable instructions, when executed by the at least one processor of the publisher computing device, cause the at least one processor, in publishing the audit count to the message bus, to publish the audit event to a third topic, which is different than the first topic and the second topic.

17. The non-transitory computer-readable storage medium of claim 14, wherein the executable instructions, when executed by the at least one processor of the publisher computing device, cause the at least one processor to:
determine that the audit interval is complete; and
retrieve the event IDs for the audit interval, prior to providing the event IDs for each of the plurality of events.

18. The non-transitory computer-readable storage medium of claim 14, wherein the executable instructions, when executed by the at least one processor of the publisher computing device, cause the at least one processor to retrieve, form a data structure, the missing ones of the plurality of events, prior to republishing the missing ones of the plurality of events.

19. The non-transitory computer-readable storage medium of claim 14, wherein the executable instructions, when executed by the at least one processor of the publisher computing device, cause the at least one processor to consume, from the message bus, the request for event IDs from the consumer as an event published to a third topic.

20. The non-transitory computer-readable storage medium of claim 19, wherein the executable instructions, when executed by the at least one processor of the publisher computing device, cause the at least one processor to consume, from the message bus, the request to republish missing ones of the plurality of events from the consumer as an event published to a fourth topic.
